(19) United States
(12) Patent Application Publication
(10) Pub. No.: US 2007/0007213 A1
(43) Pub. Date: Jan. 11, 2007

(54) Water filtration process and apparatus

(76) Inventors: John W. MacPherson JR., Cedar Crest, NM (US); Marlon Curtis, West Monroe, LA (US); Jeff K. Hairston, Monroe, LA (US)

Correspondence Address: John M. Harrison, 2139 E. Bert Kouns, Shreveport, LA, 71105, US

(21) Appl. No.: 11/475,659

(22) Filed: Jun. 27, 2006

Related U.S. Application Data
(60) Provisional application No. 60/697,247, filed on Jul. 8, 2005.

(51) Int. Cl. C02F 1/52

(52) U.S. Cl. 210/702

(57) ABSTRACT

A water filtration process and apparatus which includes the steps of treating well water with a coagulating agent or flocculant such as aluminum sulfate and/or potassium permanganate and aluminum chlorohydrate and directing the treated effluent water stream containing positively charged coagulated contaminant particles into a series of filter chambers packed with finely crushed rocks, sand and/or negatively-charged glass filter medium of random particle size. The water is filtered through the glass filter medium from top to bottom and the filtered potable effluent removed from the bottom of the filter chambers and typically directed to a storage tank. A closed-system, clarified water recycle backwash system is also provided, wherein water clarified in a series of interconnected backwash tanks is introduced into the well water effluent line and filtered as the potable filtered effluent is back-flushed through backwashed filter chamber or chambers in a desired sequence, to remove the impurities, residue and chemicals from the glass filter media. The accumulated impurities, residue and chemicals introduced with the backwash water into the backwash tanks are periodically removed from the tanks, typically by vacuum trucks.

### BACKGROUND OF THE INVENTION

One of the problems which exists in producing clean, potable water from well water and other source water, is that of removing chemicals such organics which become haloorganics, including trihalomethanes and haloacetic acids when chlorine is added to the treated water. Conventional sand filters commonly used in water treatment systems are not sufficiently efficient to reduce the concentration of these impurities to an acceptable level without additional expensive treatment. The problem is particularly acute in rural areas where many water supply wells have become contaminated due to the infusion and migration of impurities such as organics, haloorganics and other chemicals, because of oil and gas drilling and production activities and the pollution of lakes and rivers from illegal dumping of chemicals and toxic materials.

### SUMMARY OF THE INVENTION

This invention relates to filtration systems and more particularly, to a water filtration process and apparatus which is designed to provide potable water of high quality from well water using a series of filter chambers for receiving water which has been pretreated with such coagulating and flocculating agents such as aluminum sulfate, potassium permanganate and aluminum chlorohydrate and filtering the water through a filter medium of finely crushed glass, rocks and/or sand having multi-faceted, irregularly-shaped particles of different size and typically having a negative electrostatic charge. Since the suspended solid particles of impurities in the well water, which include organics such as methane, hydrogen sulfide, and acetic acid, in non-exclusive particular, are typically coagulated and positively charged due to the action of the aluminum sulfate or other treating agent the filtration process is greatly enhanced to produce water of high quality by the electrostatic attraction between the glass or alternative filter medium and the coagulated particles, which remain on the filter medium as residue. The turbidity of the water is also greatly reduced, since the finely ground, highly angular, typically amorphous crushed glass filter medium is characterized by multi-surface glass particles of irregular size and shape, wherein the irregular faces provide good surface contact with the effluent water, thus stripping the undesirable chemicals with the coagulated and turbid particles from the water. A closed, recycle backwash loop or system is also provided, wherein backwash tanks are connected in a clarifying arrangement for introducing clarified water and optionally, a polymer such as non-ionic polyacrylamide into the filter effluent stream and backflushing or washing selected ones of the filter chambers and medium at selected intervals with clean, filtered, potable water which has been filtered through the remaining on-line filter chambers. The polymer aids in settling contaminants in the backwashed effluent. The accumulated chemical and other material residue removed from the glass filter medium due to the backflushing or washing operation is introduced with the backwash water into the backwash tanks and after settling by gravity, is removed as bottom residue from the backwash tanks on a periodic basis, typically by use of vacuum trucks.

### BRIEF DESCRIPTION OF THE DRAWINGS

The invention will be better understood by reference to the accompanying drawings, wherein:

FIG. 1 is a schematic flow diagram of a preferred embodiment of the water filtration process and apparatus of this invention, particularly illustrating a flow of effluent water from a water well to a treatment system and through four chamber filters, typically having a crushed glass filter medium, to a storage tank, as well as a closed backflush or backwash water recycle and clarifying system for use in backflushing and washing the filter chamber medium;

FIG. 2 is a top elevation and schematic diagram of the water filtration process and apparatus illustrated in FIG. 1, more particularly illustrating the flow of treated water well effluent through the four crushed glass medium filter chambers illustrated in FIG. 1 from the top to the bottom thereof, with the filtered effluent directed away from the filter chambers to storage and further illustrating a preferred positioning of the closed system backwash water clarifying tanks and associated equipment for backflushing or backwashing the filter chambers and filter medium in a selected sequence;

FIG. 3 is an elevation of a typical injection tank taken along line 3-3 of the water filtration apparatus illustrated in FIG. 2 and containing water treatment material such as aluminum sulfate and/or potassium permanganate and aluminum chlorohydrate and a companion pump for injecting the aluminum sulfate into the stream of well water at a mixer for treating the well water;

FIG. 4 is an elevation of the filter chambers taken along line 4-4 of the water filtration apparatus illustrated in FIG. 2, more particularly illustrating a preferred effluent and effluent water piping layout, wherein the treated well water flows from an intake header into the top of each of the filter chambers and through the crushed glass filter medium, bed and from the chamber bottom into a collection line, as filtered, potable effluent;

FIG. 5 is an elevation of the injection tank and one end of the filter chamber bank, along with the backflush tank bank, taken along line 5-5 of the water filtration apparatus illustrated in FIG. 2, more particularly illustrating a preferred process layout and structure;

FIG. 6 is an elevation of the backflush tanks and pump illustrated in FIGS. 1 and 2; and

FIG. 7 is a table illustrating the water effluent and effluent contaminant composition before and after filtration.

### DESCRIPTION OF THE PREFERRED EMBODIMENTS

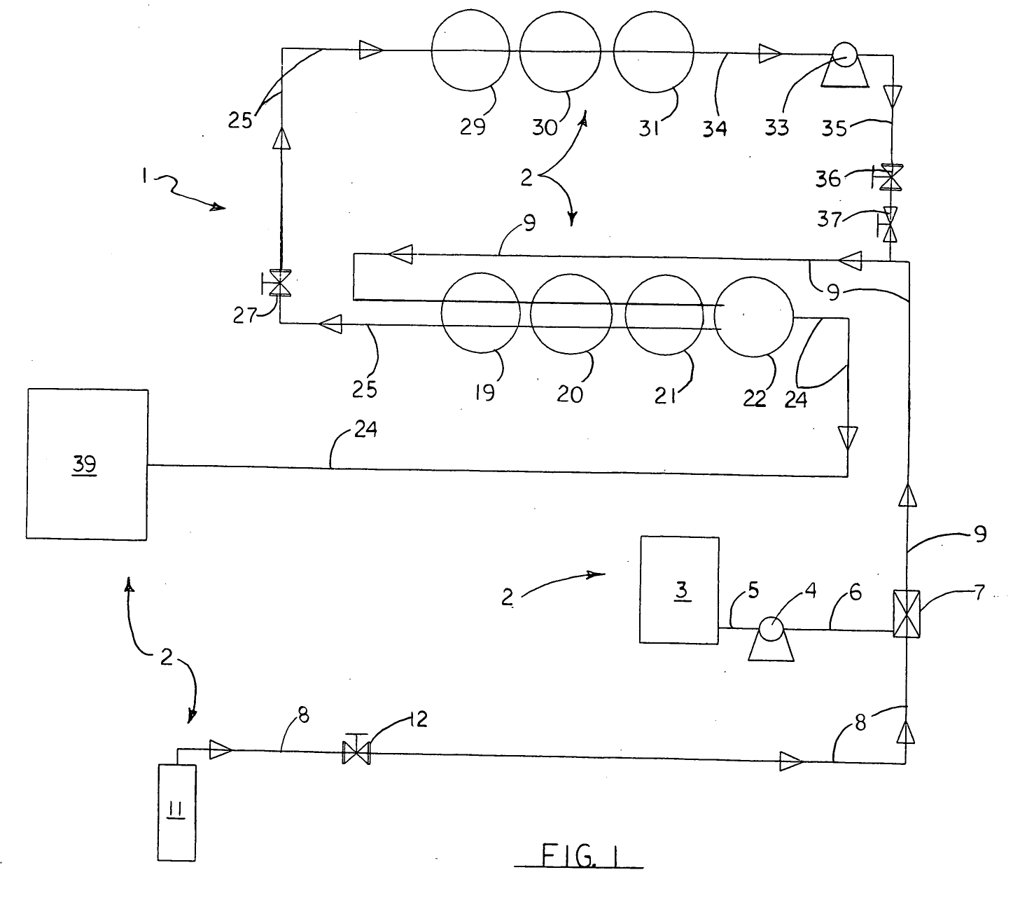

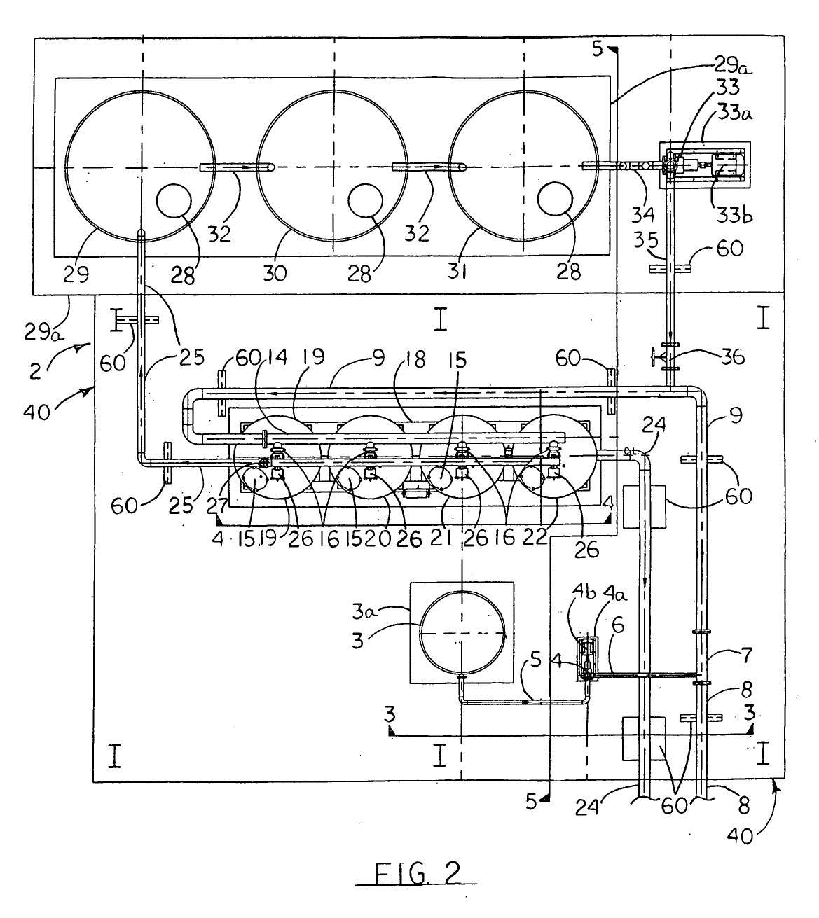

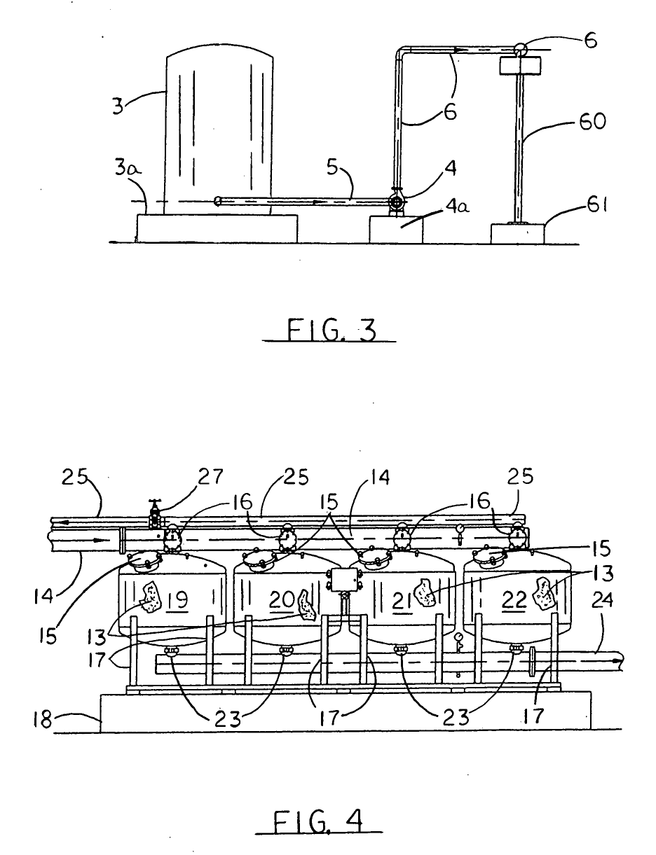

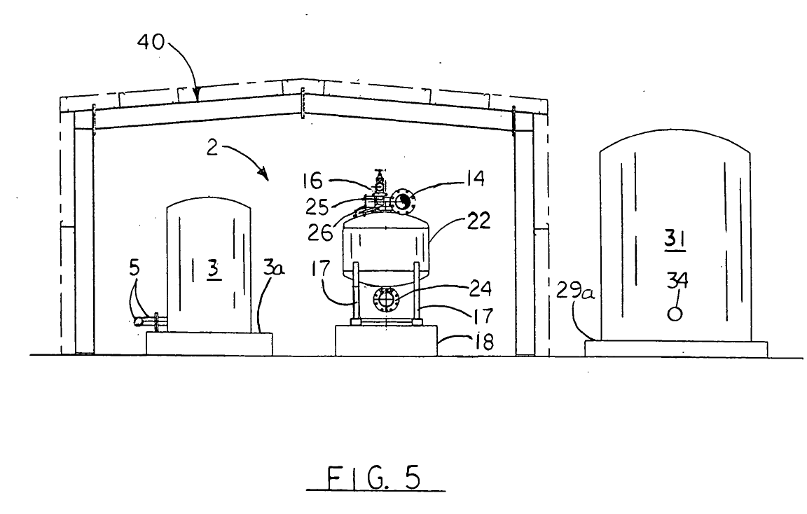

Referring initially to FIGS. 1-4 of the drawings, in a preferred embodiment of the invention the water filtration process and apparatus of this invention is characterized by a water filtration process 1, using a filtration apparatus 2, which includes an injection tank 3 and an injection pump 4, mounted on an injection tank pad 3a and an injection pump pad 4a (FIG. 3), as well as an injection pump suction line 5, connecting the injection tank 3 to the injection pump 4. An injection pump discharge line 6 projects from the discharge of the injection pump 4 to a mixer 7, which also receives raw well water pumped from the water well 11, flowing through the mixer water intake line 8 into the mixer 7. A coagulant or flocculating treating agent such as aluminum sulfate and/or potassium permanganate and aluminum chlorohydrate is mixed with the incoming well water in the mixer 7 in conventional fashion to provide a treated well water effluent having a positive electrostatic coagulated particle charge. In a preferred embodiment a water line check valve 12 is provided in the mixer water intake line 8 to prevent treated well water from back-flowing from the mixer 7 into the water well 11 when the well pump (not illustrated) is not operating. A mixer discharge line 9 extends from the mixer 7 and carries the treated well water effluent into a filter chamber intake header 14, as illustrated in FIGS. 2 and 4 of the drawings. From the filter chamber intake header 14, the treated well water effluent enters the top of a first filter chamber 19, second filter chamber 20, third filter chamber 21 and fourth filter chamber 22, through the intake ports (not illustrated) of corresponding effluent feed valves 16 (FIGS. 2 and 4). In a preferred embodiment a set of discharge ports (not illustrated) provided in the respective effluent feed valves 16 are connected to a filter chamber backwash line 25, as illustrated in FIG. 2, for purposes which will be hereinafter described. The first filter chamber 19, second filter chamber 20, third filter chamber 21 and fourth filter chamber 22 each have a filter chamber access cover 15 and are typically characterized as commercial sand filters such as the Miami sand filter produced by Miami Filter of Ft. Pierce, Fla. The filter chambers are typically arranged in a bank of four, each resting on filter chamber supports or legs 17, positioned on a common filter chamber pad 18. As the treated well water effluent enters the first filter chamber 19, second filter chamber 20, third filter chamber 21 and fourth filter chamber 22 through the intake ports of the respective effluent feed valves 16, the water is filtered, typically through a mass or bed of finely crushed, highly angulated, typically recycled glass filter medium 13 (FIG. 4) located therein. Alternatively, other filter media such as finely crushed rocks, sand and the like can be used with or without the crushed glass filter medium. The crushed glass filter medium is clean, lightweight and has multi-faceted, irregular faces on glass particles of irregular size. The crushed glass is preferred as a filter medium because it is negatively charged and as such, attracts the coagulated, positively-charged particles of common impurities-containing contaminant chemicals such as organics, including methane, acetic acid, hydrogen sulfide and the like, in non-exclusive particular, as further hereinafter described. The treated well water effluent flows downwardly through the respective beds of filter medium 13 and exits the first filter chamber 19, second filter chamber 20, third filter chamber 21 and fourth filter chamber 22, through the respective effluent discharge valves 23, which are connected to a common filter chamber discharge line 24, as further illustrated in FIGS. 1 and 2 of the drawings. The filter chamber discharge line 24 typically extends to a storage tank 39, where the filtered, potable well water effluent is stored for future use, as illustrated in FIG. 1.

Referring again to FIGS. 1-6 of the drawings, in a preferred embodiment of the invention the filter chamber backwash line 25 extends over each of the first filter chamber 19, second filter chamber 20, third filter chamber 21 and fourth filter chamber 22. The respective filter chambers may be connected to the filter chamber backwash line 25 by means of the respective discharge ports (not illustrated) provided in the effluent feed valves 16, as described above. Alternatively, the filter chamber backwash line 25 may be connected to the filter chambers by corresponding backwash feed valves 26, respectively, as further illustrated in FIG. 2. A backwash feed line valve 27 is typically provided in the filter chamber backwash line 25 downstream of the respective backwash feed lines 26, for controlling the flow of return backflush or backwash water from the first filter chamber 19, second filter chamber 20, third filter chamber 21 and the fourth filter chamber 22. The recycled backwash water may be treated with a polymer such as non-ionic polyacrylamide and is typically stored and clarified in a closed system or loop which includes a first backwash tank 29, a second backwash tank 30 and a third backwash tank 31, interconnected by respective backwash tank connecting lines 32 and cross-over piping 32a to allow cross-flow of the tank contents. The clarified backwash water in the third backwash tank 31 is delivered to the mixer discharge line 9 that connects to the filter chamber intake header 14 through a backwash pump discharge line 35. A backwash pump 33 is connected to the backwash pump discharge line 35 and a backwash pump suction line 34 extends from the suction of the backwash pump 33 to the third backwash tank 31, as further illustrated in FIGS. 1, 2 and 6 of the drawings. The backwash tank lines 32 connect the respective first backwash tank 29, second backwash tank 30 and third backwash tank 31, respectively, at decreasing height, for successively clarifying the closed supply of backwash water used in the backwashing of the filter chambers, as hereinafter further described. A backwash valve 36 is also provided in the backwash pump discharge line 35 to prevent well water effluent from flowing through the backwash pump discharge line 35, the backwash pump 33 and the backwash pump suction line 34, into the third backwash tank 31. The backwash valve 36 also facilitates operation of the backwash pump 33 to maintain a flow of clarified water from the third backwash tank 31, through the backwash pump suction line 34 and the backwash pump 33 and into the backwash pump discharge line 35 and the mixer discharge line 9. The backwash pump 33 is typically operated by a backwash pump motor 33b and both the backwash pump 33 and the backwash pump motor 33b are typically seated on a backwash pump pad 33a, as further illustrated in FIG. 2 of the drawings. As further illustrated in FIG. 1 of the drawings, a check valve 37 may be also be provided in the backwash pump discharge line 35 to further insure that water does not flow from the mixture discharge line 9 in reverse, through the backwash pump 33 and into the third backwash tank 31.

As further illustrated in FIGS. 2, 5 and 6 of the drawings, the first backwash tank 29, second backwash tank 30 and third backwash tank 31 are typically located on a common backwash tank pad 29a and are typically each fitted with a tank access cover 28 and a sludge removal valve 38, the latter designed for removing backwash residue from the bottoms of the tanks using a vacuum truck (not illustrated). Furthermore, the respective piping, such as the mixer discharge line 9, filter chamber backwash line 25 and like piping can be elevated and supported on pipe supports 60, resting on pipe support pads 61, as illustrated.

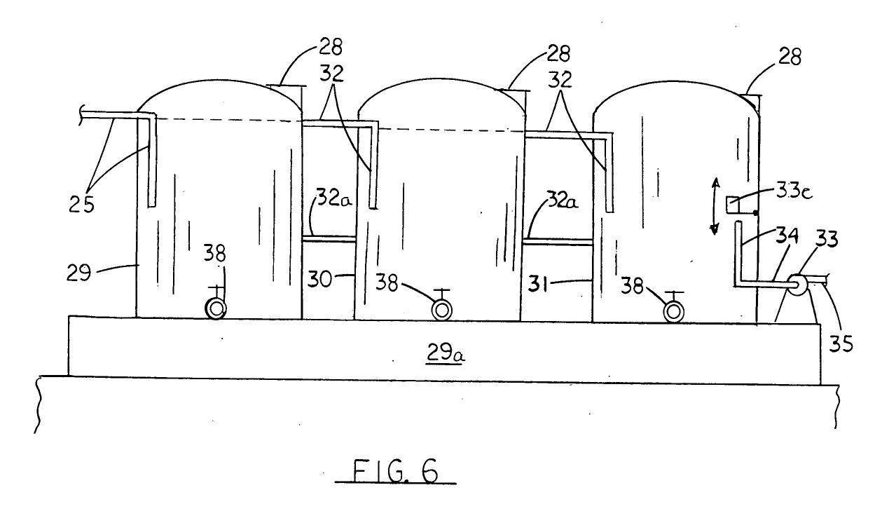

Referring now to FIGS. 2 and 5 of the drawings, in another preferred embodiment of the invention certain elements of the filtration apparatus 2, including the first filter chamber 19, second filter chamber 20, third filter chamber 21 and fourth filter chamber 22, as well as the injection tank 3 and related equipment, may be located in a structure 40 of suitable size and construction, typically a metal building of suitable design. In contrast, the taller first backwash tank 29, second backwash tank 30, third backwash tank 31 are typically located outside of the structure 40. However, it will be appreciated by those skilled in the art that the entire complement of filtration apparatus 2, including the backwash system, of this invention can be located in an open area or in any desired structure and in any particular operating order and location, according to selected design requirements.

It will be further appreciated by those skilled in the art that use of the crushed glass water filtration medium 13 (FIG. 4) of this invention has produced surprisingly good results in providing a filtered water effluent product having an exceptionally high quality, primarily because of the qualities of the highly angular, crushed glass medium and the efficiency of the closed system, clarified water backwash system. The crushed glass medium used in this invention features multi-faceted, irregular facets or surfaces on each of the many particles of irregular size and has a negative charge as described above, for electrostatically attracting the positively-charged, coagulated contaminant particles, which include organics such as methane, hydrogen sulfide and acetic acid and the like. Furthermore, the reduced weight of this glass medium as compared to sand filter medium, provides more filter volume per pound of material and the lower density requires up to twenty percent less medium to fill the respective first filter chamber 19, second filter chamber 20, third filter chamber 21 and fourth filter chamber 22. The finely crushed glass medium 13 used in this invention is typically supplied by Trivitro Corporation of Kent, Washington, and facilitates a filtered effluent having the surprising characteristics displayed in Table I, illustrated in FIG. 7 of the drawings.

Referring again to FIGS. 1, 2 and 4 of the drawings, in a typical filtration and backwashing sequence raw water is pumped from the water well 11 (FIG. 1), through the mixer water intake line 8 and into the mixer 7, where it is mixed with treatment ingredients such as aluminum sulfate, potassium permanganate, and aluminum chlorohydrate or mixtures of these, in non-exclusive particular, to coagulate the impurities in the well water and induce a positive electrostatic charge to these particles. The treated effluent well water is then pumped from the mixer 7 through the mixture discharge line 9 and into the filter chamber intake header 14 illustrated in FIGS. 2 and 4 of the drawings. Water from the filter chamber intake header 14 is pumped through the respective effluent feed valves 16 into the first filter chamber 19, second filter chamber 20, third filter chamber 21 and fourth filter chamber 22. The effluent feed water is then distributed through the filter medium 13 illustrated in FIG. 4 of the drawings, where the positively-charged, coagulated particulate material in the well water is removed by contact with the crushed glass filter medium 13. The clean, potable, filtered water is then directed from the first filter chamber 19, second filter chamber 20, third filter chamber 21 and the fourth filter chamber 22, through the respective effluent discharge valves 23 into a common filter chamber discharge line 24, where it is typically directed to a storage tank 39 as further illustrated in FIG. 1 of the drawings. Alternatively, the filtered potable water stream flowing through filter chamber discharge line 24 may be directed to an end user distribution system or water works serving a community or otherwise, according to the knowledge of those skilled in the art.

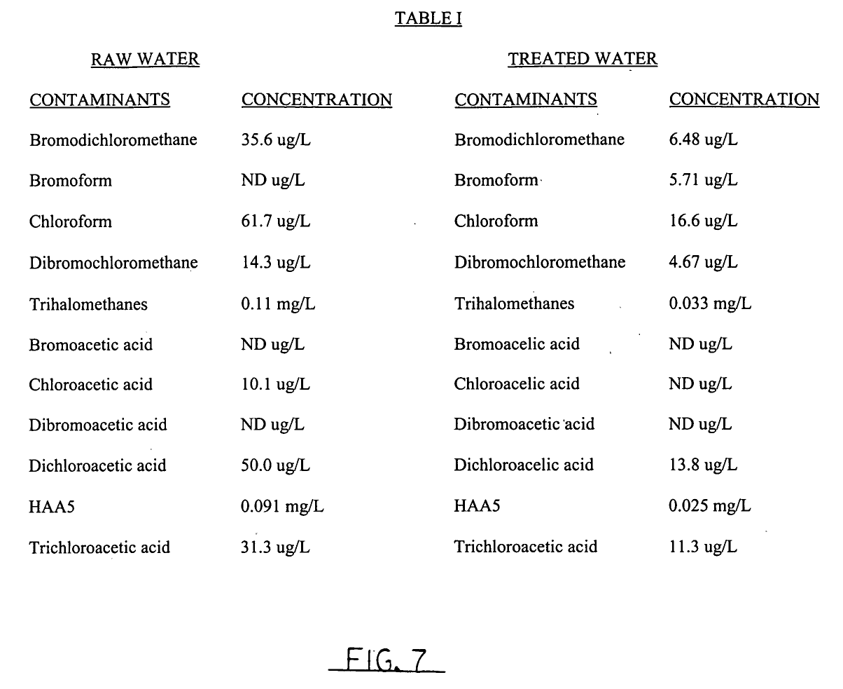

Under circumstances where it is desired to backwash or backflush one or more of the first filter chamber 19, second filter chamber 20, third filter chamber 21 and the fourth filter chamber 22 while the remaining filter chambers remain on-line, the corresponding effluent feed valve or valves 16 are closed and the companion effluent discharge valve or valves 23 which connect to the filter chamber discharge line 24, are opened. Alternatively, the discharge ports of the effluent feed valves 16 can be opened to the filter chamber discharge line 24 under circumstances where the effluent discharge valves 23 are not used. Furthermore, the backwash pump 33 is activated, thus causing clarified water to flow from the third backwash tank 31 through the backwash pump suction line 34 and the backwash pump 33 and into the backwash pump discharge 35. Water in the backwash pump discharge line 35 then flows into the mixer discharge line 9 and then to the filter chamber intake header 14, for filtration with the treated well water. Since the intake ports of the effluent feed valves 16 are now closed, water cannot flow from the filter chamber intake header 14 through these filter chambers. However, since the discharge ports of the effluent feed valves 16 or the backwash feed valves 26 are open to the filter chamber backwash line 25, clear effluent water is caused to flow from the pressurized filter chamber discharge line 24, through the corresponding open effluent discharge valve or valves 23 and then reverse-flow through the filter medium 13, to clean the filter medium 13 and flush the filtered residue from the filter chambers being backwashed, into the filter chamber backwash line 25. This contaminated backwash water may be treated with a polymer such as non-ionic polyacrylamide and the water flows through the filter chamber backwash line 25 into the top of the first backwash tank 29, where it is distributed at approximately the midpoint therein, as illustrated in FIG. 6 of the drawings. Accordingly, the residue introduced into the first backwash tank 29 with the backwash water flowing through the filter chamber backwash line 25 settles to the bottom of the first backwash tank 29, while the partially clarified water overflows into the second backwash tank 30 through a backwash tank connecting line 32, the entrance of which is typically positioned about 4 inches lower than the entrance of the filter chamber backwash line 25 in the first backwash tank 29. Similarly, additional residue in the water flowing through the first backwash tank connecting line 32 settles to the bottom of the second backwash tank 30 and the clearer water overflows through a second backwash tank connecting line 32 into the connecting third backwash tank 31, as further illustrated in FIG. 6 of the drawings. As in the case of the first backwash tank connecting line 32, the entrance or intake of the second backwash connecting line 32 into the third backwash tank 31 is about four inches lower than the backwash connecting line 32 which connects the first backwash tank 29 to the second backwash tank 30. This arrangement insures that backwash water of increasing clarity flows from the first backwash tank 29 through the second backwash tank 30 and into the third backwash tank 31, while also insuring that the contaminated residue collected from the backwashing of the respective first filter chamber 19, second filter chamber 20, third filter chamber 21 and fourth filter chamber 22 in sequence, settles by gravity to the bottom of each of the first backwash tank 29, second backwash tank 30, third backwash tank 31, where it is periodically removed through the respective sludge removable valves 38, typically using a vacuum truck (not illustrated).

It will be appreciated by those skilled in the art that the backwash system provided in the water filtration process 1 of this invention is a closed loop, recycle system wherein clarified water is periodically pumped from the third backwash tank 31 through the respective on-line first filter chamber 19, second filter chamber 20, third filter chamber 21 and fourth filter chamber 22, in selected combinations and back through the off-line filter chambers in countercurrent flow to the normal filtration path. This arrangement cleans the corresponding filter medium 13 provided in these filter chambers without the necessity of discarding the contaminated water to the environment. The contaminants are periodically removed from each of the first backwash tank 29, second backwash 30 and third backwash tank 31 through the respective sludge removal valves 38 by any convenient means, such as vacuum trucks or the like, according to the knowledge of those skilled in the art.

It will be further appreciated by those skilled in the art that the closed loop, recycle backwash system of this invention is characterized by high efficiency, since the water used to backwash each of the first filter chamber 19, second filter chamber 20, third filter chamber 21 and the fourth filter chamber 22 in a selected sequence, is of high quality, having been first clarified and then filtered and pumped into the filter chamber discharge line 24. The clean, potable water is caused to reverse-flow as described above through selected ones of the first filter chamber 19, second filter chamber 20, third filter chamber 21 and fourth filter chamber 22, while the remaining on-line filter chambers are filtering the well water and clarified water from the third backwash tank 31, to produce a continuous stream of clean, potable water to the storage tank 39. Accordingly, the system is characterized by great efficiency and minimum environmental impact, since it rarely needs to be shut down and indeed, depends upon a continuous stream of potable, fresh filtered water to complete the backwash phase of the process. Consequently, at least one and preferably two or three of the first filter chamber 19, second filter chamber 20, third filter chamber 21 and the fourth filter chamber 22 remain on-line, producing clean, potable water for emission through the filtered chamber discharge line 24 to provide both product and backwash water for the filter chambers which are concurrently in the backwash phase of the process.

It will be further appreciated by those skilled in the art that the backwash sequence can be initiated either manually, by manually closing the respective intake and discharge ports or passages in the effluent feeder valves 16 and opening the corresponding effluent discharge valves 23, or automatically using solenoid valve technology, according to the knowledge of those skilled in the art. Furthermore, the filtration apparatus 2 can be fitted with a timer that facilitates backwashing at preselected intervals determined by the pressure drop across the filter medium 13 or by other factors inherent in the system. Still further in the alternative, the backwash procedure can be automatically initiated by a pressure switch (not illustrated) when the pressure drop across the filter medium 13 from the effluent feed valves 16 to the effluent discharge valves 23 reaches a predetermined level, thus triggering the backwash sequence.

Referring again to FIG. 6 of the drawings, in another preferred embodiment of the invention a backwash pump float switch 33c may be provided in the third backwash tank 31 to terminate operation of the backwash pump 33 under circumstances where the clarified water in the third backwash tank 31 reaches a predetermined level in the third backwash tank 31. Accordingly, the backwash pump float switch 33c serves as a safeguard to prevent loss of prime in the backwash pump 33 under circumstances where the water level in the third backwash tank 31 falls below the intake of the backwash pump suction line 34.

While the preferred embodiments of the invention have been described above, it will be recognized and understood that various modifications may be made in the invention and the appended claims are intended to cover all such modifications which may fall within the spirit and scope of the invention.

Having described my invention with the particularity set forth above,

What is claimed is:

1. A water filtration apparatus for treating influent water from a source, comprising a mixer for introducing a treatment material into the influent water, coagulating impurities in the influent water and providing a positive charge on the impurities; at least two filters for receiving the influent water; a crushed glass filter medium having multi-faceted particles and a negative electrical charge for filtering the influent water; water influent piping for connecting the source to said mixer and said mixer to said filters for introducing the influent water into said filters; at least one pump for pumping the influent water from the source through said water influent piping and through said filter and said filter medium to produce potable effluent water; and water effluent piping extending from said filters for distributing the filtered potable effluent water.

2. The water filtration apparatus of claim 1 comprising a storage facility for receiving the potable effluent water flowing from said filters through said water effluent piping.

3. The water filtration apparatus of claim 1 comprising a closed filter backwash system for introducing backwash water into said filters, filtering the backwash water to produce potable effluent water and flushing said filter medium with the potable effluent water.

4. The water filtration apparatus of claim 1 comprising:
(a) a storage facility for receiving the potable effluent water flowing from said filters through said water effluent piping; and
(b) a closed filter backwash system for introducing backwash water into said filters, filtering the backwash water to produce potable effluent water and flushing said filter medium with the potable effluent water.

5. The water filtration apparatus of claim 1 comprising at least one influent flow valve provided in said influent piping for controlling the flow of influent water to said filters.

6. The water filtration apparatus of claim 1 comprising at least one effluent flow valve provided in said effluent piping for controlling the flow of effluent water from said filters into said effluent piping.

7. The water filtration apparatus of claim 1 comprising:
(a) at least one influent flow valve provided in said influent piping for controlling the flow of influent water to said filters; and
(b) at least one effluent flow valve provided in said effluent piping for controlling the flow of effluent water from said filters into said effluent piping.

8. The water filtration apparatus of claim 7 comprising a storage facility for receiving the potable effluent water flowing from said filters through said water effluent piping.

9. The water filtration apparatus of claim 7 comprising a closed filter backwash system for introducing backwash water into said filters, filtering the backwash water to produce potable effluent water and flushing said filter medium with the potable effluent water.

10. The water of claim 7 comprising:
(a) a storage facility for receiving the potable effluent water flowing from said filters through said water effluent piping; and
(b) a closed filter backwash system for introducing backwash water into said filters flushing the backwash water to produce potable effluent water and flushing said filter medium with the effluent water.

11. A water filtration apparatus for producing potable water from a water influent source, comprising a plurality of filter chambers and a crushed glass filter medium having amorphous particles of irregular size and multiple facets or faces provided in said filter chambers; influent water piping extending from the water influent source to said filter chambers for delivering the influent water to said filter chambers and said crushed glass medium; water effluent piping extending from said filter chambers to a storage facility for delivering filtered potable effluent water to the storage facility; at least one influent water pump provided in said influent water piping for pumping the influent water through said influent piping and said filter chambers and said potable effluent water from said filter chambers through said effluent piping to said storage facility; and a closed system filter backwash system for introducing backwash water into said filter chambers with the influent water and flushing said filter medium with the potable effluent water.

12. The water filtration apparatus of claim 11 comprising at least one influent flow valve provided in said influent piping and at least one effluent flow valve provided in said effluent piping for controlling the flow of the influent water from the source into said filter chambers and said potable effluent water from said filter chambers into said storage facility, respectively.

13. A process for producing drinking water with a water treatment system comprising the steps of:
mixing influent water from a source with a coagulant to coagulate particles of impurities in the influent water and apply a positive electrostatic charge to the particles;
providing at least two filtering vessels having a crushed glass filter medium therein;
introducing the influent water into the filtering vessels and filtering the influent water through the crushed glass filter medium to produce filtered effluent water; and
providing a closed loop backwash system communicating with the filtering vessels for introducing clarified water into the filtering vessels and backwashing the filter medium using the filtered effluent water to produce backwash water.

14. The process of claim 13 comprising the step of providing at least one backwash tank, a backwash pump and backwash piping in the closed loop backwash system for delivering the clarified water to the filtering vessels and removing the backwash water from the filtering vessels and delivering the backwash water to the backwash tank.

15. The process of claim 14 wherein said at least one backwash tank comprises a plurality of interconnected backwash tanks for producing the clarified water for delivering to the filtering vessels.
